(19) United States
(12) Patent Application Publication
(10) Pub. No.: US 2026/0293855 A1
(43) Pub. Date: Oct. 1, 2026

(54) WEIGHT ESTIMATION METHOD AND PROGRAM

(71) Applicant: SEIKO EPSON CORPORATION, Tokyo (JP)

(72) Inventor: Hikaru KURASAWA, Matsumoto-shi (JP)

(21) Appl. No.: 19/577,504

(22) Filed: Mar. 25, 2026

(30) Foreign Application Priority Data
Mar. 26, 2025 (JP) 2025-051454

(51) Int. Cl. A01K 29/00; G01G 17/08; G06T 3/60; G06T 7/60; G06T 7/73; G06V 10/32; G06V 10/75; G06V 10/764; G06V 10/766; G06V 10/82; G06V 40/10

(52) U.S. Cl. CPC A01K 29/002; G01G 17/08; G06T 3/60; G06T 7/60; G06T 7/73; G06V 10/32; G06V 10/751; G06V 10/764; G06V 10/766; G06V 40/10; G06T 2207/10028; G06T 2207/20081; G06T 2207/20084; G06V 10/82

(57) ABSTRACT

A weight estimation method for estimating a weight of a cow includes: (a) imaging the cow from directly above to acquire a depth image; (b) estimating an orientation of the cow in the depth image; (c) rotating the depth image in a way that the orientation of the cow is a predetermined orientation; (d) matching a size of the depth image after the rotation to a predetermined reference size, and outputting a reference size image; and (e) inputting the reference size image to a regression model to acquire an estimated weight of the cow output by the regression model.

The present application is based on, and claims priority from JP Application Serial Number 2025-051454, filed Mar. 26, 2025, the disclosure of which is hereby incorporated by reference herein in its entirety.

### BACKGROUND

### 1. Technical Field

The present disclosure relates to a weight estimation method and a program.

### 2. Related Art

In the technology described in JP-A-2023-014766, to estimate the weight of a cow, a depth image as a result of imaging the cow is input to a classification model that is one of machine learning models, and a class in terms of estimated weight is output.

JP-A-2023-014766 is an example of the related art.

In the technology described in JP-A-2023-014766, the classes in terms of weight are classified every 10 kg. The weight is used as an index for grasping the growth state of a cow. However, for example, in the case of a nursed cow before it is weaned from the breast or a nursed cow after it is weaned from the breast but before it becomes pregnant, the growth state of the cow cannot be sufficiently grasped by the classification in increments of 10 kg. It has therefore been desired to more precisely estimate the weight of a cow.

### SUMMARY

The present disclosure can be implemented in the form of aspects below.

According to an aspect of the present disclosure, a weight estimation method for estimating a weight of a cow is provided. The weight estimation method includes: (a) imaging the cow from directly above to acquire a depth image; (b) estimating an orientation of the cow in the depth image; (c) rotating the depth image in a way that the orientation of the cow is a predetermined orientation; (d) matching a size of the depth image after the rotation to a predetermined reference size, and outputting a reference size image; and (e) inputting the reference size image to a regression model to acquire an estimated weight of the cow output by the regression model.

According to another aspect of the present disclosure, a program executed by a computer is provided. The program causes a computer to realize: (a) imaging a cow from directly above to acquire a depth image; (b) estimating an orientation of the cow in the depth image; (c) rotating the depth image in a way that the orientation of the cow is a predetermined orientation; (d) matching a size of the depth image after the rotation to a predetermined reference size, and outputting a reference size image; and (e) inputting the reference size image to a regression model to acquire an estimated weight of the cow output by the regression model.

### BRIEF DESCRIPTION OF THE DRAWINGS

FIG. 1 illustrates a schematic configuration of a weight estimation system according to an embodiment of the present disclosure.

FIG. 2 is a flowchart showing an overall procedure of estimating the weight of a cow.

FIG. 3 is a flowchart showing a specific procedure of data preprocessing.

FIGS. 4A to 4F illustrate the flow of a series of steps of data preprocessing performed by an image processing portion.

FIG. 5 illustrates feature points of the body of the cow viewed from directly above.

FIG. 6 illustrates an example in which the data preprocessing is performed on depth images as a result of imaging cows having different sizes.

FIG. 7 illustrates some of the feature points of the body of a calf viewed from directly above.

### DESCRIPTION OF EMBODIMENTS

### A. Embodiment

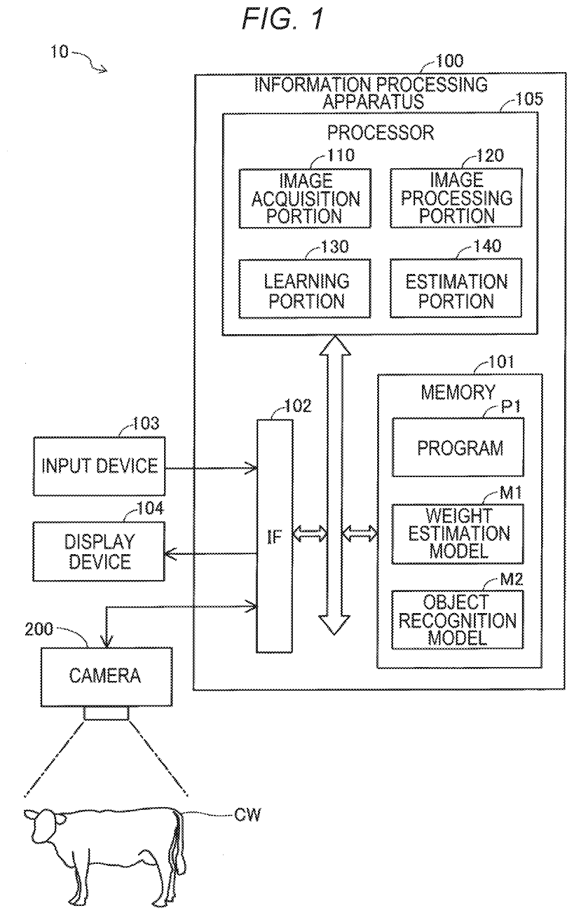

FIG. 1 illustrates a schematic configuration of a weight estimation system 10 according to an embodiment of the present disclosure. The weight estimation system 10 estimates the weight of a cow CW. The weight estimation system 10 includes an information processing apparatus 100 and a camera 200.

The camera 200 is used to image the cow CW. The camera 200 is disposed at a position where the camera 200 can image the cow CW from directly above. For example, the camera 200 is disposed above a passage in a cow shed where the cow CW walks around. The camera 200 images the back of the cow CW. The camera 200 is a depth camera capable of acquiring a depth image. Each pixel of the depth image contains information indicating the distance from the camera 200 to a subject. The camera 200 can communicate with the information processing apparatus 100 via wireless or wired communication. Note that the cow CW an image of which is being captured with the camera 200 may be moving, but is desirably standing still.

The information processing apparatus 100 carries out the process of estimating the weight of the cow CW by using the depth image acquired with the camera 200. The information processing apparatus 100 is configured, for example, with a personal computer. The information processing apparatus 100 includes a memory 101, an interface circuit 102, an input device 103 and a display device 104 coupled to the interface circuit 102, and a processor 105. The camera 200 is also coupled to the interface circuit 102. The memory 101 stores programs and data used in various processes carried out by the information processing apparatus 100. In the example shown in FIG. 1, a program P1, a weight estimation model M1, and an object recognition model M2 are stored in the memory 101. The weight estimation model M1 and the object recognition model M2 will be described later.

The information processing apparatus 100 includes an image acquisition portion 110, an image processing portion 120, a learning portion 130, and an estimation portion 140. The processor 105 executes the program P1 stored in the memory 101 to realize the functions of the portions described above.

The image acquisition portion 110 acquires a depth image of the cow CW. The image processing portion 120 performs predetermined image processing on the depth image acquired by the camera 200 before a weight estimation process carried out by the estimation portion 140.

The learning portion 130 performs deep learning to create the weight estimation model M1. The learning portion 130 generates the weight estimation model M1 by performing deep learning using a set of learned data in which a depth image as a result of imaging a cow from directly above is used as input data and a measured value of the weight of the cow is used as a ground truth label. The timing of acquiring the measured value of the weight of the cow is desirably the same as or close to the timing of acquiring the depth image as the input data. In addition, the orientation of the cow in the depth image as the input data is aligned with a predetermined orientation. The weight estimation model M1 is a convolutional neural network model and is a regression model that predicts continuous values. The estimation portion 140 carries out the process of estimating the weight of the cow CW by using the weight estimation model M1.

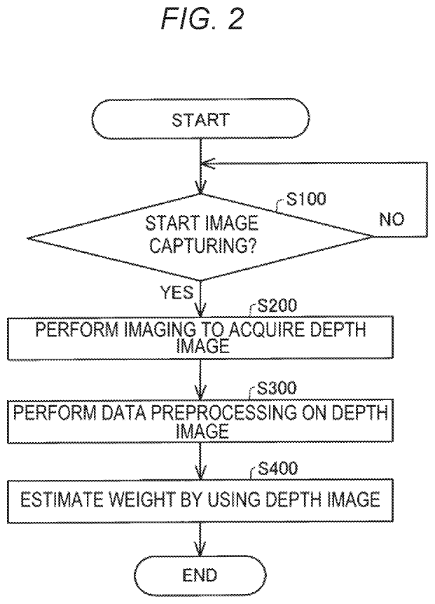

FIG. 2 is a flowchart showing an overall procedure of estimating the weight of the cow CW. Before the process shown in FIG. 2 is initiated, a learned weight estimation model M1 is generated by the learning portion 130.

In step S100, the camera 200 determines whether to start image capturing. The imaging start condition is that the area occupied in the field of view by an object having appeared in the field of view exceeds a predetermined threshold. When the start condition is satisfied (YES in step S100), the process in step S200 is carried out. It is assumed that the camera 200 has a moving object detection function.

In step S200, the camera 200 performs imaging to acquire a depth image of the cow CW. The camera 200 transmits the acquired depth image to the information processing apparatus 100. The image acquisition portion 110 stores the received depth image in a predetermined region of the memory 101 along with reception time and most recently received individual identification information. For example, the camera 200 repeats the imaging until a predetermined number of depth images are acquired, and transmits the acquired depth images to the information processing apparatus 100. Upon acquisition of the predetermined number of depth images, the camera 200 stops imaging. Instead, the camera 200 may stop imaging when the movement of a moving object in the field of view is small.

In step S300, the image processing portion 120 performs data preprocessing, which is the predetermined image processing, on the depth image acquired by the camera 200. The data preprocessing is processing intended to process a depth image acquired by the camera 200 into data suitable for input to the weight estimation model M1. Details of the data preprocessing will be described later.

In step S400, the estimation portion 140 inputs the image on which the data preprocessing has been performed to the weight estimation model M1, and acquires an estimated weight output by the weight estimation model M1. The estimation portion 140 outputs an estimation result image representing the estimated weight to the display device 104. The display device 104 displays the estimation result image.

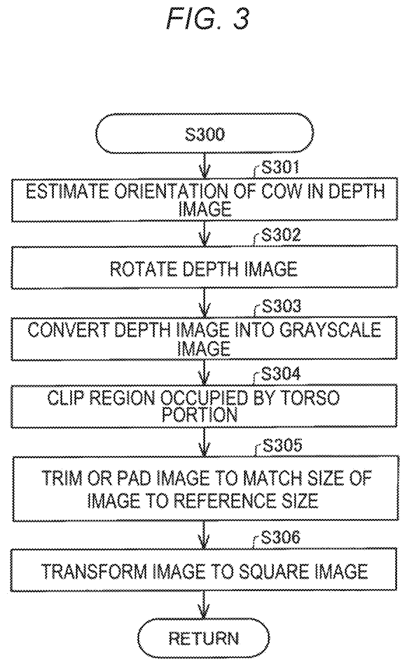

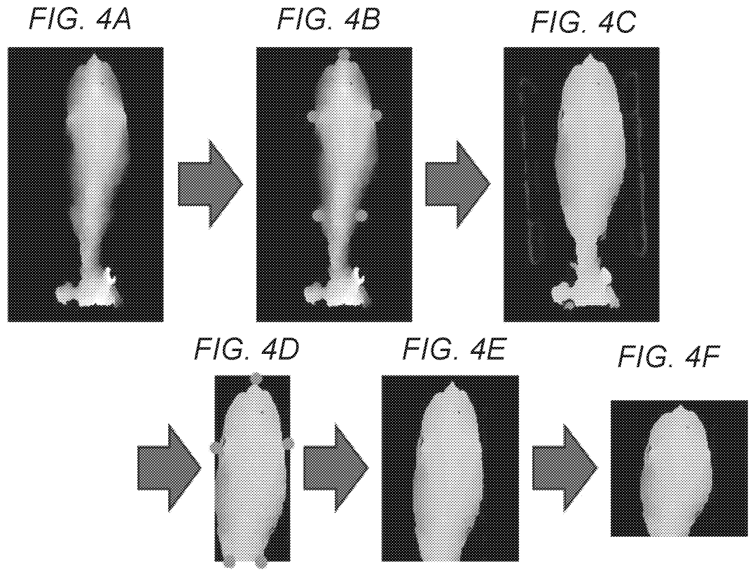

FIG. 3 is a flowchart showing a specific procedure of the data preprocessing in step S300 in FIG. 2. FIG. 4 illustrates the flow of a series of steps of the data preprocessing performed by the image processing portion 120.

In step S301, the image processing portion 120 estimates the orientation of the cow CW in the depth image, as shown in FIG. 3. To estimate the orientation of the cow CW, the image processing portion 120 first extracts a set of feature points indicating shape-related feature portions of the body of the cow from the depth image by using the object recognition model M2. A feature point indicates, for example, the position of a joint of the cow. The object recognition model M2 is a machine learning model that receives the depth image of the cow CW as an input and outputs a set of key points representing the feature points of the cow CW. The object recognition model M2 can be configured by using, for example, DeepLabCut.

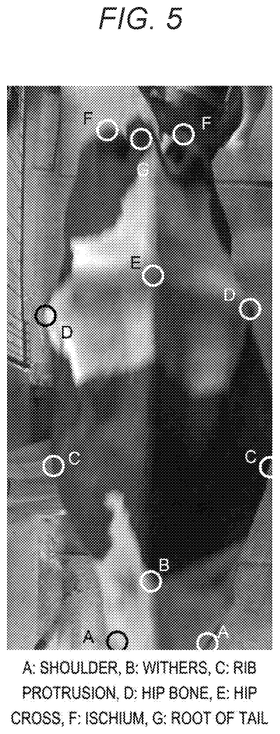

FIG. 5 illustrates the feature points of the body of the cow CW viewed from directly above. Note that the example shown in FIG. 5 is not a depth image. In FIG. 5, portions that can be detected as the feature points of the body of the cow CW are surrounded by circles. For example, the shoulders, the neck, the withers, rib protrusions, the hip bones, the hip cross, the ischium, and the root of the tail are detected as the feature points of the body. In FIG. 5, the shoulder joints are referred to as the shoulders. Definitions of the portions other than the shoulders, the ischium, and the root of the tail will be described below.
Neck: a portion where a straight line that couples the right and left shoulders to each other intersects with the backbone
Withers: a back-side portion of the shoulder blade, which is the highest portion at the back of the cow viewed sideways
Rib protrusions: portions where the ribs of the cow viewed from above protrude most
Hip bones: portions where angular tips of the pelvis protrude
Hip cross: a portion where a straight line that couples the right and left hip bones to each other intersects the backbone

4A shows a depth image of the cow CW acquired with the camera 200. 4B shows an example in which a set of key points is extracted. The image processing portion 120 estimates the orientation of the cow in the depth image by using coordinates indicating the position of each of the key points in the depth image. The image processing portion 120 identifies, in the depth image, an imaginary first straight line that couples the key points representing the right and left hip bones or the right and left shoulders of the cow CW to each other, identifies an imaginary second straight line perpendicular to the imaginary first straight line and passing through the key point representing the root of the tail. The imaginary second straight line is perpendicular to the imaginary first straight line in a two-dimensional plane. The second straight line identified in the present embodiment represents the orientation of the cow.

In step S302, the image processing portion 120 rotates the depth image in a way that the orientation of the cow CW in the depth image is aligned with a predetermined orientation, as shown in FIG. 3. The predetermined orientation is the same as the orientation of the cow in the depth image as the input data used in the deep learning performed by the learning portion 130. The reason for this is that the orientation of the cow in the depth image as the input data used in the deep learning, which generates the weight estimation model M1, has been aligned with the predetermined orientation, as described above. The image processing portion 120 rotates only the region occupied by the cow in the depth image in a way that the imaginary second straight line is parallel to the vertical direction of the depth image. Rotating the region occupied by the cow in the depth image allows the orientation of the cow in the depth image to be aligned with the predetermined orientation. In an aspect in which the orientation of the cow in the depth image is not aligned with the predetermined orientation, it is necessary to provide depth images of the cow having various orientations as depth images contained in the set of learned data in the deep learning. In the present embodiment, the orientation of the cow in the depth image as the input data is aligned with the predetermined orientation. The deep learning is therefore more readily performed than in the aspect in which the orientation of the cow in the depth image as the input data is not aligned with the predetermined orientation. Furthermore, it is expected that the estimation accuracy of the generated weight estimation model M1 is improved.

In step S303, the image processing portion 120 converts the depth image into a grayscale image by adjusting the distance information relating to each of the pixels contained in the depth image in accordance with a certain reference. FIG. 4C shows an example of the grayscale image as a result of the conversion.

The distance from the camera 200 to the cow, which is the subject, varies depending on the size of the cow. Therefore, the maximum and the minimum of the value of the distance information contained in the depth image vary on a depth image basis. The minimum and the maximum of the distance assumed to be the distance from the camera 200 to the cow are therefore defined in advance. For example, the minimum and the maximum are determined to be one meter and two meters, respectively. When the pixels of the grayscale image are each expressed by 8 bits, the minimum of the pixel value in the grayscale image is “0” and the maximum of the pixel value is “255”. The image processing portion 120 associates the maximum “two meters” and the minimum “one meter” with the pixel value “0” and the pixel value “255” in the grayscale image, respectively. The pixel value in the grayscale image therefore ranges from 0 to 255 in accordance with the distance in the depth image. Since the grayscale image is created by replacing the pixel values of the depth image in accordance with the method described above, the distance information can be evaluated based on a common scale for multiple depth images in the process after step S304.

In step S304, the image processing portion 120 clips the region occupied by the cow's trunk portion in the grayscale image by using the coordinates indicating the positions of the key points in the depth image, and outputs a first image. The coordinates of the positions of the key points in the depth image coincide with the coordinates of the positions of the key points in the grayscale image. The coordinates indicating the positions of the key points in the depth image after the rotation can be calculated in accordance with the amount of the rotation in step S302. FIG. 4D shows an example of the clipped first image. For example, a vertical distance Dl of the clipped range is identified based on the coordinates of the position of the key point representing one of the shoulders and the coordinates of the position of the key point representing the root of the tail. A horizontal distance Dw of the clipped range is identified based on the coordinates of the position representing each of the right and left hip bones. The clipped range is determined so as to contain at least the range defined by the identified vertical distance Dl and horizontal distance Dw. In the example shown in FIG. 4D, the clipped range is the combination of the range defined by the vertical distance Dl and the horizontal distance Dw and a certain margin set around the range. When the cow is viewed from above, the rib protrusions may protrude most. Furthermore, when the cow is viewed from above, the key point indicating the root of the tail may not be located at the outer edge of the cow. Clipping the range containing a certain margin can prevent some of the key points from being lost due to the clipping of the image.

In step S305, the image processing portion 120 matches the size of the first image to a predetermined reference size by trimming or padding the first image. FIG. 4E shows an example of the image having a size matched to the reference size. The image processing portion 120 couples the key points representing the right and left hip bones or the right and left shoulders of the cow viewed from directly above to each other with the imaginary first straight line. The image processing portion 120 trims or pads the first image in a way that the length of the imaginary second straight line perpendicular to the imaginary first straight line and passing through the key point representing the root of the tail is a certain length measured from the key point representing the root of the tail. The trimming or padding in the description is performed to match the vertical size of the image to the predetermined reference size. The vertical size of the first image is thus matched to the predetermined reference size. The image processing portion 120 further trims or pads the first image in a way that the imaginary first straight line has a certain length. The trimming or padding in the description is performed to match the horizontal size of the image to the certain size. The horizontal size of the first image is thus matched to the certain size. Note that when it is assumed that a target cow is a cow having a standard size, it is desirable that the portion from the root of the tail to one of the shoulders is contained in the image. The image having the size matched to a reference size is also referred to as a “reference size image”.

In step S306, the image processing portion 120 compresses the reference size image in the vertical direction to transform the reference size image into a square image, as shown in FIG. 3. The reason for this is that an image to be input to the weight estimation model M1 is preferably a square image because the weight estimation model M1 is a convolutional neural network model. Note that the process in step S305 may not be carried out.

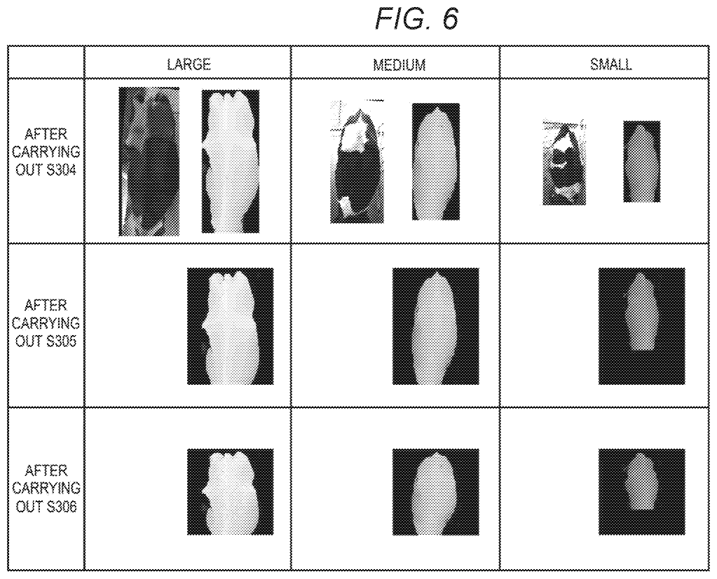

FIG. 6 illustrates an example in which the data preprocessing is performed on depth images as a result of imaging cows having different sizes. After the process in step S304, that is, after the process of clipping the region occupied by the cow's trunk portion, the size of the first image showing the clipped cow's trunk portion varies among a large cow, a medium cow, and a small cow. In the present embodiment, the size of the first image is matched to the predetermined reference size by trimming or padding the first image in the process in step S305. Furthermore, in the process in step S306, the reference size image is compressed in the vertical direction to transform the reference size image into a square image. The size of an image to be input to the weight estimation model M1 is matched to a certain size. The series of procedures of the data preprocessing have been described.

As described above, in the present embodiment, since the depth image as a result of imaging the cow from directly above is used, the camera 200 that acquires a depth image only needs to be installed, for example, above the passage along which the cow passes, so that a depth image can be readily acquired. In the aspect using the weight class classification as in the related art, for example, it is difficult to sufficiently grasp the growth state of a nursed cow before it is weaned from the breast or a nursed cow after it is weaned from the breast but before it becomes pregnant. In addition, even in the case of a dairy cow, the amount of lactation changes in accordance with the number of days from birth, so that it is difficult to sufficiently grasp the health condition in the aspect using the weight class classification. In the present embodiment, since an estimated weight of the cow can be obtained in the form of continuous values by using a regression model as the weight estimation model M1, the weight of the cow can be estimated more precisely.

### B. Other Embodiments

(B1) When the target cow is a dairy cow, it is desirable that the measured value of the weight of the cow as the ground truth label contained in the set of learned data is acquired immediately after the milking work is performed. In the case of a dairy cow, the weight thereof greatly varies before and after the milking. In view of the fact described above, deep learning using learned data in which a measured value of the weight acquired immediately after the milking is used as the ground truth label is performed. The weight estimation accuracy in the weight estimation model M1 generated by the deep learning can thus be increased. Timings immediately after the milking work is performed include not only timings immediately after the milking work is completed, but also timings after the milking work is completed but before food and water are given to the cow and before the cow excretes.

The measured value of the weight of the cow CW is desirably acquired before feeding. The term “before feeding” refers to a state which is before food and water are given to a cow and in which the cow cannot eat food nor drink water. For example, it is desirable to measure the weight of the cow CW immediately before feeding work of supplying food to the feed bunk is performed. In the case of a cow, the weight thereof greatly varies before and after the feeding. In view of the fact described above, deep learning using learned data in which a measured value of the weight acquired before the feeding is used as the ground truth label is performed. The weight estimation accuracy in the weight estimation model M1 generated by the deep learning can thus be increased.

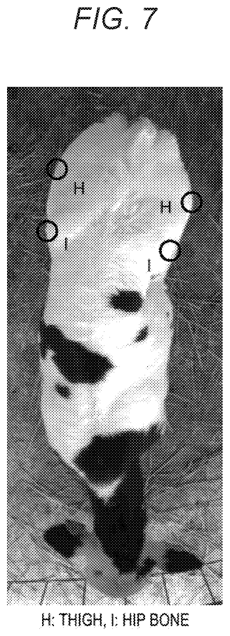

(B2) FIG. 7 illustrates some of the feature points of the body of a calf viewed from directly above. In step S301 in FIG. 3, the feature points of the body of the cow CW that are detected as the key points may include thigh protruding portions. In FIG. 7, the thigh protruding portions are referred to as thighs. The thigh protruding portions are each a portion where the thigh protrudes most when the cow is viewed from above. In the case of a calf, the thigh protruding portions may protrude rightward and leftward by a greater amount than the hip bones (see FIG. 5). In this case, it is desirable to detect the thigh protruding portions, which are the portions protruding most rightward and leftward and clip the trunk portion. Note that key points other than the hip bones and the thighs are not shown in FIG. 7, and the shoulders, the withers, the rib protrusions, the hip cross, the ischium, and the root of the tail can be detected as the key points also in the case of a calf.

(B3) The above embodiment has been described with reference to the estimation of the orientation of a cow in which the imaginary second straight line perpendicular to the imaginary first straight line, which couples the key points representing the right and left hip bones or the right and left shoulders of the cow viewed from directly above passes through the key point representing the root of the tail. The imaginary second straight line may be a straight line passing through the key point representing the hip cross in place of the key point representing the root of the tail. The second straight line may be a straight line passing through the key point representing the withers in place of the key point representing the root of the tail. The second straight line may be a straight line passing through the key point representing at least one of the hip cross, the withers, and the root of the tail.

(B4) In the embodiment described above, the method of using key points to estimate the orientation of a cow has been described. The orientation of a cow may instead be estimated by another method. An example of the other method will be described below.

An ellipse containing the range occupied by the cow in the depth image is superimposed on the depth image, and the major axis of the ellipse can be estimated as the orientation of the cow. When the depth image is rotated (see step S302 in FIG. 3), the region of the ellipse may be so rotated that the major axis of the ellipse is parallel to the vertical direction of the depth image. When the region occupied by the trunk portion of the cow is clipped in the image (see step S304 in FIG. 3), the region of an ellipse the major axis of which has a preset length may be clipped.

A bounding box indicating the region of the cow in the depth image can be acquired by using a known object detection algorithm, and the orientation of the long sides of the bounding box can be estimated as the orientation of the cow. When the depth image is rotated (see step S302 in FIG. 3), the depth image may be so rotated that the long sides of the bounding box are parallel to the vertical direction of the depth image. When the region occupied by the trunk portion of the cow is clipped in the image (see step S304 in FIG. 3), the region in the bounding box may be clipped.

A template image showing the cow viewed from directly above is provided in advance, and the cow in the depth image is detected by template matching. The center line extending in the direction of the long sides of a detected rectangular region can be estimated as the orientation of the cow. When the depth image is rotated (see step S302 in FIG. 3), the rectangular region may be so rotated that the long sides of the detected rectangular region are parallel to the vertical direction of the depth image. When the region occupied by the trunk portion of the cow is clipped in the image (see step S304 in FIG. 3), the detected rectangular region may be clipped.

(B5) In the embodiment described above, when the size of the first image is matched to the predetermined reference size (see step S305 in FIG. 3), the size of the image in the vertical direction is so matched that the length of the imaginary second straight line is a certain length measured from the key point representing the root of the tail. The reference position used to trim or pad the first image may be one of the shoulders or the neck. In this case, the size of the image in the vertical direction may be so matched that the length measured from the shoulder has a certain length.

(B6) The camera 200 images the cow CW for a certain period of time, so that multiple depth images are acquired after the cow CW enters the imaging range. The process in step S300 and the process in step S400 shown in FIG. 2 may therefore be carried out for each of the depth images. The estimation result image displayed on the display device 104 in step S400 may show estimated weights based on the multiple depth images, or may show a representative value such as a mean, a median, or a mode of the estimated weights based on the multiple depth images. The information processing apparatus 100 may not perform the data preprocessing on a depth image that does not contain the entire trunk of the cow, a depth image in which no key point has been detected, and other incomplete depth images and may not use the depth images in the weight estimation.

The present disclosure is not limited to the embodiments described above, and can be implemented in various configurations without departing from the intent of the present disclosure. For example, technical features in the embodiments corresponding to technical features in the aspects described in the summary of the disclosure can be replaced with other technical features or combined with each other as appropriate to solve part or all of the problems described above or to achieve part or all of the advantages described above. Furthermore, any of the technical features can be eliminated as appropriate unless described as essential in the present specification.

### C. Other Aspects

(1) According to an aspect of the present disclosure, a weight estimation method for estimating a weight of a cow is provided. The weight estimation method includes: (a) imaging the cow from directly above to acquire a depth image; (b) estimating an orientation of the cow in the depth image; (c) rotating the depth image in a way that the orientation of the cow is a predetermined orientation; (d) matching a size of the depth image after the rotation to a predetermined reference size, and outputting a reference size image; and (e) inputting the reference size image to a regression model to acquire an estimated weight of the cow output by the regression model.

According to the aspect described above, an estimated weight of the cow can be obtained in the form of continuous values by using a regression model. Since the depth image is so rotated that the orientation of the cow is a predetermined orientation, an image in which the orientation of the cow is aligned with the predetermined orientation is input to the regression model. Since the depth image as a result of imaging the cow from directly above is used, the camera that acquires a depth image only needs to be installed, for example, above the passage along which the cow passes, so that a depth image can be readily acquired.

(2) In the weight estimation method according to the aspect described above, (c) may include (c1) extracting a set of feature points indicating feature portions of a body of the cow from the depth image, (c2) estimating the orientation of the cow based on a second straight line perpendicular to a first straight line in a two-dimensional plane, the first straight line coupling the feature points indicating the feature portions to each other, which are right and left portions of the cow, in the depth image, and (c3) rotating the depth image in a way that the second straight line indicating the orientation of the cow is aligned with a vertical direction of the image.

(3) In the weight estimation method according to the aspect described above, in (c2), the feature portions may include at least one of an ischium, a hip bone, a shoulder, a protruding portion of an abdomen, and a protruding portion of a thigh.

(4) In the weight estimation method according to the aspect described above, in (c2), the second straight line may pass through at least one of a hip cross, withers, and a root of a tail.

(5) In the weight estimation method according to the aspect described above, (d) may include (d1) clipping a region occupied by a trunk portion of the cow in the depth image by using coordinates of the feature points in the depth image, and outputting a first image, and (d2) trimming or padding the first image in a way that the second straight line in the first image has a certain length measured from the root of the tail to match a size of the first image to the reference size, and outputting the reference size image.

The first image, which is the depth image from which the trunk portion of the cow is clipped, varies in accordance with the size of the cow. According to the aspect described above, the size of the reference-size image to be input to the regression model can be matched to a certain size by trimming or padding the first image.

(6) In the weight estimation method according to the aspect described above, the regression model may be generated by deep learning using a set of learned data in which the depth image as a result of imaging the cow from directly above is used as input data and a measured value of the weight of the cow is used as a ground truth label.

(7) In the weight estimation method according to the aspect described above, when the cow is a dairy cow, a timing of acquiring the measured value of the weight of the cow may be immediately after milking work is performed.

In the case of a dairy cow, the weight thereof greatly varies before and after the milking. In view of the fact described above, deep learning using learned data in which a measured value of the weight acquired immediately after the milking is used as the ground truth label is performed. The weight estimation accuracy in the weight estimation model M1 generated by the deep learning can be increased.

(8) In the weight estimation method according to the aspect described above, the timing of acquiring the measured value of the weight of the cow may be before feeding.

(9) According to another aspect of the present disclosure, a program executed by a computer is provided. The program causes a computer to realize: (a) imaging a cow from directly above to acquire a depth image; (b) estimating an orientation of the cow in the depth image; (c) rotating the depth image in a way that the orientation of the cow is a predetermined orientation; (d) matching a size of the depth image after the rotation to a predetermined reference size, and outputting a reference size image; and (e) inputting the reference size image to a regression model to acquire an estimated weight of the cow output by the regression model.

What is claimed is:

1. A weight estimation method for estimating a weight of a cow, the method comprising:
(a) imaging the cow from directly above to acquire a depth image;
(b) estimating an orientation of the cow in the depth image;
(c) rotating the depth image in a way that the orientation of the cow is a predetermined orientation;
(d) matching a size of the depth image after the rotation to a predetermined reference size, and outputting a reference size image; and
(e) inputting the reference size image to a regression model to acquire an estimated weight of the cow output by the regression model.

2. The weight estimation method according to claim 1,
wherein (c) includes
(c1) extracting a set of feature points indicating feature portions of a body of the cow from the depth image,
(c2) estimating the orientation of the cow based on a second straight line perpendicular to a first straight line in a two-dimensional plane, the first straight line coupling the feature points indicating the feature portions to each other, which are right and left portions of the cow, in the depth image, and
(c3) rotating the depth image in a way that the second straight line indicating the orientation of the cow is aligned with a vertical direction of the image.

3. The weight estimation method according to claim 2,
wherein in (c2), the feature portions include at least one of an ischium, a hip bone, a shoulder, a protruding portion of an abdomen, and a protruding portion of a thigh.

4. The weight estimation method according to claim 2,
wherein in (c2), the second straight line passes through at least one of a hip cross, withers, and a root of a tail.

5. The weight estimation method according to claim 4,
wherein (d) includes
(d1) clipping a region occupied by a trunk portion of the cow in the depth image by using coordinates of the feature points in the depth image, and outputting a first image, and
(d2) trimming or padding the first image in a way that the second straight line in the first image has a certain length measured from the root of the tail to match a size of the first image to the reference size, and outputting the reference size image.

6. The weight estimation method according to claim 1,
wherein the regression model is generated by deep learning using a set of learned data in which the depth image as a result of imaging the cow from directly above is used as input data and a measured value of the weight of the cow is used as a ground truth label.

7. The weight estimation method according to claim 6,
wherein when the cow is a dairy cow, a timing of acquiring the measured value of the weight of the cow is immediately after milking work is performed.

8. The weight estimation method according to claim 7,
wherein the timing of acquiring the measured value of the weight of the cow is before feeding.

9. A program that causes a computer to realize:
(a) imaging a cow from directly above to acquire a depth image;
(b) estimating an orientation of the cow in the depth image;
(c) rotating the depth image in a way that the orientation of the cow is a predetermined orientation;
(d) matching a size of the depth image after the rotation to a predetermined reference size, and outputting a reference size image; and
(e) inputting the reference size image to a regression model to acquire an estimated weight of the cow output by the regression model.
